(19) United States
(12) Patent Application Publication
(10) Pub. No.: US 2002/0047255 A1
(43) Pub. Date: Apr. 25, 2002

(54) Steering assembly with a fixed central pad, corresponding central pad and corresponding motor vehicle

(76) Inventors: Hugues Baume, Montbeliard (FR); Frederic Bois, Belfort (FR); Thomas Prevost, Montbeliard (FR)

Correspondence Address: YOUNG & THOMPSON, 745 SOUTH 23RD STREET 2ND FLOOR, ARLINGTON, VA, 22202

(21) Appl. No.: 09/960,384

(22) Filed: Sep. 24, 2001

(30) Foreign Application Priority Data
Sep. 22, 2000 (FR) 00 12 118

(51) Int. Cl. B62D 1/18

(52) U.S. Cl. 280/775; 280/771

(57) ABSTRACT

This steering assembly for a motor vehicle comprises a steering shaft, a steering wheel (3) and a fixed central pad (4). The pad comprises at least one button (50, 51) for operating an item of equipment of the vehicle. The button is moveable in rocking in a first direction (60, 65) towards a first active operating position, and in a second direction (61, 66) towards a second active operating position. The pad comprises a radial projection (35) on at least one of its lateral sides and in which the button lies flush. The projection is far enough away from a geometric envelope of revolution defined by the rotation of the spokes (7) of the steering wheel and containing the rim (5) of the steering wheel that it allows the button, in any one of its positions, to be pushed in the first direction (60, 65) by the thumb of one hand of a driver holding a portion of the rim, and pushed in the second direction (61, 66) by the index finger and/or the middle finger of the same hand holding the same portion of the rim.

The present invention relates to a steering assembly for a motor vehicle, of the type comprising:

a steering column comprising a steering shaft capable of turning about a longitudinal axis,

a steering wheel comprising an outer rim and at least one spoke connected by a first end to the rim and by a second end to the rear end of the steering shaft to drive it in rotation about its longitudinal axis,

a fixed central pad placed substantially at the centre of the steering wheel at the rear of the second end of the or of each spoke and connected to the rear end of the column so as to be fixed in terms of rotation when the steering shaft is turning, the pad comprising at least one button for operating an item of equipment of the vehicle, the button lying flush in the central pad and being moveable in rocking between a position of rest and at least one active operating position.

In general, in a motor vehicle comprising an assembly of the aforementioned type, a shell-like trim element or sleeve covers the rear end of the steering column in order to conceal it. This sleeve extends forward as far as the dashboard to which it is connected. This sleeve is surmounted by the set which groups together, on one and the same support, various dials, lamps and indicators of the monitoring equipment on board the vehicle.

A steering assembly of the aforementioned type and in which the fixed central pad is in the form of a spherical cup truncated on its upper side and equipped on its lateral sides with rocking buttons that can be moved by pushing forwards in order to operate various functional parts of the vehicle, is known.

The flat front face of the central pad substantially follows the profile of the spokes of the steering wheel. The rear face of the sleeve also substantially follows the profile of the spokes of the steering wheel and is bordered by rocking operating buttons. These buttons are flush fitting and can be moved by pulling them back in order to operate functional items of equipment of the vehicle.

The sleeve also comprises, forward of these flush-fitting operating buttons, conventional operating levers, generally known as COMMODOS (registered trademark) for operating the headlamp units and the flashing lights of the vehicle which are used to indicate that the vehicle is changing direction.

The presence of such operating buttons and levers on the sleeve makes it impossible, for the same sleeve length, to satisfactorily mount paddles for sequential gear shifting. Furthermore, increasing the length of the sleeve in order to mount such paddles would involve reducing the volume inside the cabin of the vehicle, and this is something which is not desirable.

One object of the invention is to solve this problem by providing an assembly of the aforementioned type which makes it possible, on a sleeve that conceals the rear end of the steering column, to mount paddles for sequential gear change without increasing the length of the sleeve.

To this end, the subject of the invention is a steering assembly of the aforementioned type, characterized in that the button is moveable in rocking in a first direction from its position of rest towards a first active operating position and, in a second direction which is the opposite to the first direction, from its position of rest towards a second active operating position, and in that the pad comprises a radial projection on at least one of its lateral sides, in which projection the button lies flush, which projection is far enough away from a geometric envelope of revolution defined by the rotation of the or each spoke about the longitudinal axis and containing the rim that it allows the button, in any of its positions, to be pushed in the first direction by the thumb of one hand of a driver holding a portion of the rim and pushed in the second direction by the index finger and/or middle finger of the same hand holding the same portion of the rim.

According to some particular embodiment, the assembly may comprise one or more of the following features, taken in isolation or in any technically feasible combination:

the button is moveable in rocking about an axis substantially parallel to the longitudinal axis,

the radial projection has at least one free upper end and the button is provided at this end,

the button is moveable in rocking about an axis substantially perpendicular to the longitudinal axis,

the minimum distance separating the radial projection from the said geometric envelope is greater than about 2 cm.

Another subject of the invention is a fixed central pad for an assembly as defined hereinabove, characterized in that it comprises a radial projection on at least one of its lateral sides and in which at least one button for operating an item of equipment of the vehicle lies flush, which button is moveable in rocking in a first direction from a position of rest towards a first active operating position and, in a second direction which is the opposite to the first direction, from its position of rest towards a second active operating position.

According to some particular embodiments, the pad may comprise one or more of the following features, taken in isolation or in any technically feasible combination:

the button is moveable in rocking about an axis intended to be substantially parallel to the longitudinal axis of the steering shaft,

the radial projection has a free end intended to point upwards and the button is provided at this end,

the button is moveable in rocking about an axis intended to be substantially perpendicular to the longitudinal axis of the steering shaft.

A further subject of the invention is a motor vehicle, characterized in that it comprises a steering assembly as defined hereinabove.

The invention will be better understood upon reading the description which will follow, which is given solely by way of example and with reference to the appended drawings, in which:

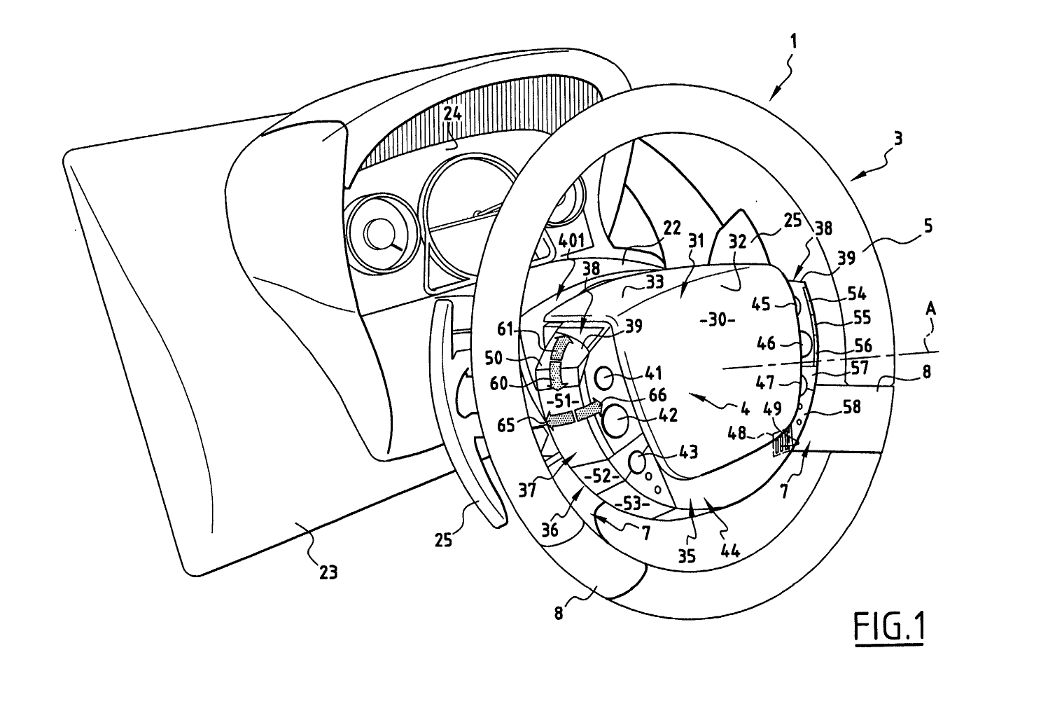

FIG. 1 is a schematic, partial and perspective view of a cabin of a motor vehicle according to the invention, illustrating the rear end of the steering assembly with which this vehicle is equipped,

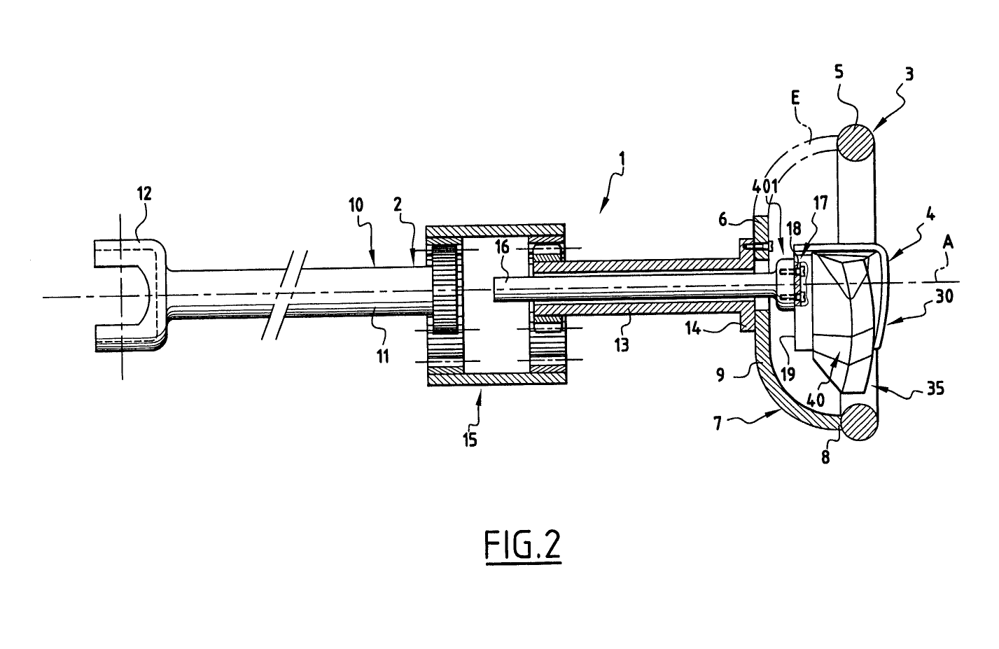

FIG. 2 is a partial, lateral, schematic view, on a smaller scale, and in part section, illustrating the steering assembly of FIG. 1, and

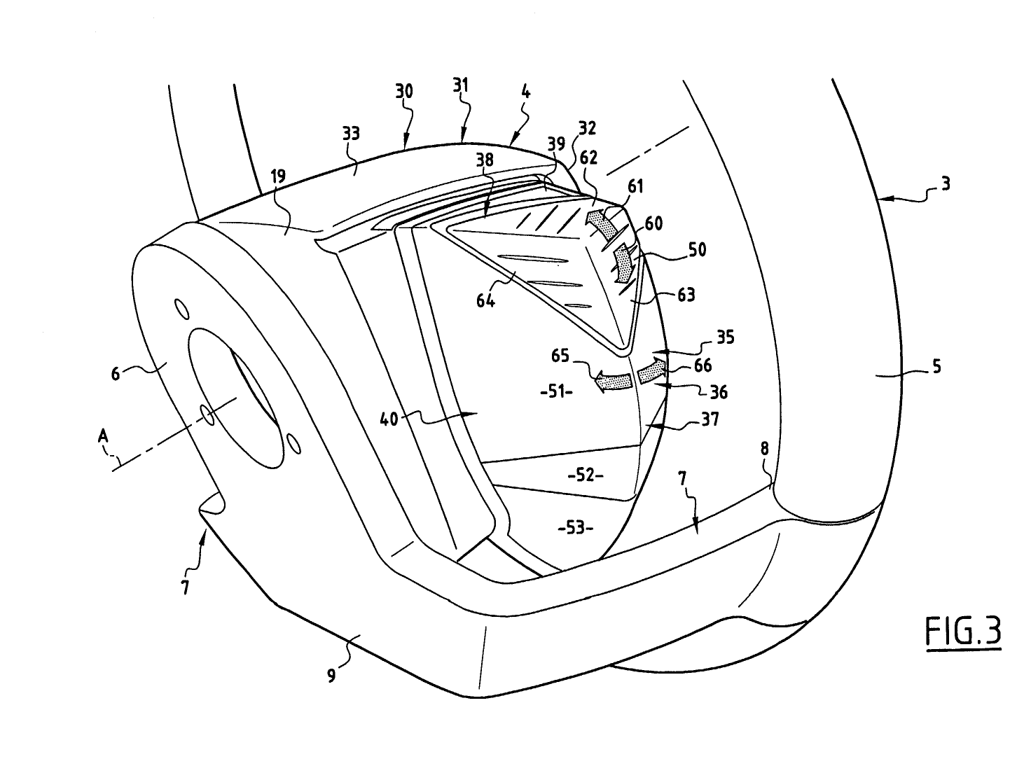

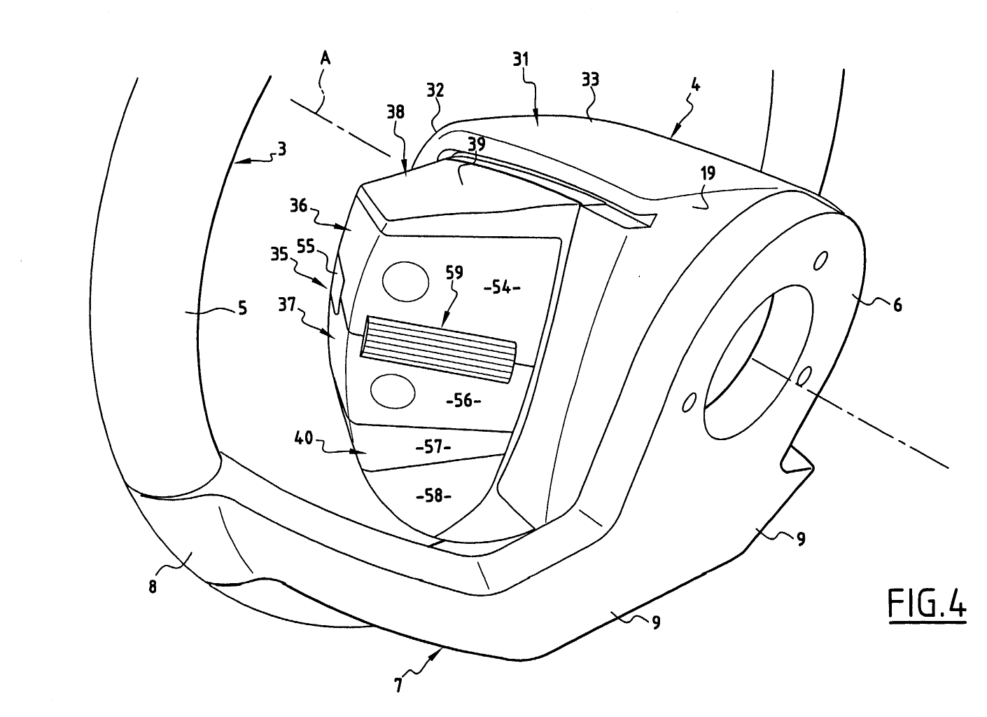

FIGS. 3 and 4 are schematic partial, enlarged and perspective views illustrating the steering wheel and the central pad of the steering assembly of FIG. 1.

In what follows, the orientations used are the conventional orientations of a motor vehicle. In particular, the terms “front” and “rear” are to be understood with respect to the position of a driver.

FIG. 1 depicts a motor vehicle equipped with a steering assembly 1.

As can be seen in FIG. 2, this steering assembly 1 comprises a steering column 2 extending along a longitudinal axis A, a steering wheel 3 and a central pad 4. The steering wheel 3 and the central pad 4 are mounted at the rear of the steering column 2.

The steering wheel 3 comprises an outer annular rim 5, a central hub 6 and spokes 7 each connected by a first end 8 to the rim 5 and by a second end 9 to the hub 6. In the example depicted, there are two spokes 7. It should be noted that the angular position of the steering wheel 3 differs between FIG. 1 and FIG. 2.

The steering column 2 comprises a steering shaft 10 that can rotate about the longitudinal axis A. The steering shaft 10 itself comprises a front portion 11 equipped at its front end with a joint half (yoke) 12 connected to the remainder (not depicted) of the steering mechanism incorporating the assembly 1, and a rear portion 13, at the rear end 14 of which the steering wheel 3 is mounted by virtue of its hub 6, for example by screwing.

The steering column 2 further comprises a device with gearing 15 arranged between the front portion 11 and rear portion 13 of the steering shaft 10, and a fixed support 16 arranged inside the rear portion 13 of the steering shaft 10 and to the rear of which the central pad 4 is fixed by virtue of mounting means 17 which, for example, comprise screws passing through orifices 18 made in the front wall 19 of the central pad 4.

The steering assembly 1 is an assembly with a fixed central pad 4 which, by virtue of the gearing device 15 and of the fixed support 16, allows a rotational movement of the rear portion 13, produced by the steering wheel 3, to be transmitted to the front portion 11 of the steering shaft 10 while the central pad 4 remains fixed.

More specifically, the assembly 1 is similar to the one described in document EP-0 825 089, where more detailed information can be found. It is to be noted that numerous other types of steering assembly with a fixed central pad are known and can be used in the context of the invention.

As can be seen in FIG. 1, the rear end of the steering column 1 is concealed by a sleeve 22 connected by its front end to the dashboard 23 of the motor vehicle. The set 24 of the motor vehicle is arranged above the front end of the sleeve 22.

The sleeve 22 is equipped on each of its lateral sides with a paddle 25 for sequential control of the motor vehicle gearbox. Each of the paddles 25 is articulated by a front end to the sleeve 22 so as to be able to pivot about an axis substantially orthogonal to the longitudinal axis A. The rear end of each paddle 25 is widened to allow it to be operated by the index finger, the middle finger, the ring finger or the little finger of one hand of the driver holding the rim 5, even when this hand has turned the steering wheel 3 through a relatively large angle about the longitudinal axis A with respect to the position depicted in FIG. 1, which corresponds to the dead-ahead position.

In particular, pulling the right-hand paddle 25 back enables an upshift by one gear and pulling the left-hand paddle 25 enables a downshift by one gear.

As illustrated by FIGS. 1 to 4, the fixed central pad 4 comprises a housing 30 of substantially rounded trapezoidal cross section, convergent downwards, and the end of which forms the front wall 19 via which the central pad 4 is connected to the fixed support 16.

This housing 30 contains an airbag module, not depicted. It is closed by a cover or pivoting flap 31 delimited in its rear wall 32 and connected to its upper wall 33 by a hinge. In the conventional way, this flap 31, which is intended to pivot to allow the airbag to deploy into the cabin of the vehicle, is mounted floating on the rest of the housing 30 so as to be able to move in the longitudinal direction A and actuate a switch that operates an audible alerting device.

The central pad 4 further comprises a radial projection 35 which surrounds the housing 30 on its two lateral sides and on its lower side.

More specifically, the projection 35 extends along an arc of a circle centred on the longitudinal axis A and interrupted substantially in the region of the upper wall 33 of the housing 30.

The edge face 36 of the projection 35 comprises a main portion 37, which substantially belongs to a cone centred on the axis A and converging towards the rear, and two terminal portions 38 at the free upper ends 39 of the projection 35. The terminal portions 38 of the edge face 36 are substantially parallel to the upper wall 33 of the housing 30.

The front face 40 of the projection 35 converges forward and towards the longitudinal axis A as can be seen in FIGS. 2 to 4.

The projection 35 is situated axially to the rear of the front wall 19 of the housing 30 and the spokes 7 of the steering wheel 3 are steeply curved and sweep back sharply from their ends 9, away from the central pad 4. Thus, the minimum distance between the radial projection 35 and the geometric envelope of revolution defined by the rotation of the spokes 7 of the steering wheel about the axis A and containing the rim 5 is greater than 2 cm and preferably greater than the thickness of a finger. This envelope is depicted in chain lines in FIG. 2 and denoted by the letter E.

As a preference, the minimum distance between the edge face 36 of the projection 35 and the rim 5 is greater than about 40 mm. In this case, the minimum distance between the projection 35 and the envelope E is reached in the region of a spoke 7. It will be noted that FIG. 2 is a schematic figure which is not to scale.

Furthermore, the housing 30 has a length in the direction of the axis A of about 90 mm, so that its rear wall 32 is spaced significantly away from the gap 401 (FIGS. 1 and 2) formed between the front wall 19 of the central pad 4 and the rear wall of the sleeve 22 and in which the ends 9 of the spokes 7 of the steering wheel 3 are housed.

The central pad 4 is equipped on its radial projection 35 with members for operating functional items of equipment of the vehicle.

More specifically, and as can be seen in FIG. 1, the central pad 4 comprises three push-buttons 41, 42 and 43, provided on the left-hand side of the rear face 44 of the projection 35, and three push-buttons 45, 46 and 47, provided on the same face 44, but on the right-hand side.

The buttons 41, 42 and 43 may, for example, operate the windscreen wipers and/or the rear screen wipers, the windscreen washer and/or the rear screen washer, and activate a cruise control device, respectively.

The buttons 45 and 46 may, for example, operate a car radio and, respectively, be used to select the source of sound, for example radio or compact disc player, and to seek a radio station by scanning frequencies. The button 47 may, for example, activate an on-board computer so that it carries out voice-recognition of instructions given by the driver and received by a microphone 48 housed in the projection 35, on its underside, in front of its rear face 44. In this case, slots 49 are formed in the rear face 44 facing the microphone 48, to make it easier for the microphone 48 to receive the sound waves.

As illustrated by FIGS. 1, 3 and 4, the central pad 4 further comprises four rocking buttons 50 to 53 on the left-hand lateral side of the projection 35, five rocking buttons 54 to 58 on the right-hand lateral side of the projection 35, and a rotary knob 59 (FIG. 4) provided on the right on the front face 40 of the projection 35.

The buttons 50 to 53, 54 and 56 to 58 lie flush in the edge face 36, in the front face 40 and in the rear face 44 of the projection 35. The button 55 is flush only in the edge face 36 and in the rear face 44 of the projection 35. The knob 59 projects slightly forwards from the front face 40.

The button 50 is arranged at the upper left-hand end 39 of the projection 35 and extends into the two corners formed between the edge face 36 and the front face 40 and rear face 44 of the projection 35. The button 50 is moveable from its stable position of rest illustrated in FIGS. 1-3 and 4, about an axis substantially parallel to the longitudinal axis A, in two opposite directions depicted by the arrows 60 and 61 towards active positions for operating the indicators of the vehicle. These two active positions are situated one on each side of the position of rest. The exterior surface of the button 50 has reliefs to limit the slipping of the fingers of the driver. By virtue of the profile of the spokes 7, and of the distance separating the projection 35 from the geometric envelope E, the driver can manipulate the button 50 in the direction 60 directed downwards, using his thumb passed round behind the rim 5 or using his index finger and/or his middle finger passed round in front of the rim 5, resting on the upper face 62 (FIG. 3) of the button 50. The button 50 then moves into its first active operating position and operates the left-hand indicators of the motor vehicle.

The driver can manipulate the button in the opposite direction 61 directed upwards, using his thumb passed round behind the rim 5 or using his index finger and/or his middle finger passed round in front of the rim 5, resting on the left-hand lateral face 63. The button 50 then moves into its second active operating position and operates the right-hand indicators.

When the driver manipulates the button 50 in the direction 60 or 61 using his index finger or his middle finger, he can rest on the front face 64 of the button 50 in addition to the upper face 62 or the lateral face 63.

The button 50 may be manipulated in the two directions 60 and 61 by the thumb and, respectively, by the index finger and/or the middle finger of the left hand of the driver placed on the rim 5 without him needing to change the position of his hand on the steering wheel. It will be noted that the two active operating positions of the button 51 are stable positions.

The button 51 substantially surrounds the button 50 and is flush only along a narrow strip in the rear face 44 of the projection 35. This button 51 can rock, from its stable position of rest depicted in FIGS. 1, 3 and 4, about an axis substantially perpendicular to the longitudinal axis A, in a first direction 65 directed forwards towards a first active position for operating the motor vehicle headlamp units and, in a second direction 66 which is the opposite to the direction 65, towards a second active position for operating the same headlamp units. The two active operating positions are unstable positions, the headlamp units being operated pulsewise.

Manipulating the button 51 in the first direction 65 can be performed by the thumb of the left hand of the driver resting against the rear or lateral faces of the button 51 and, in the second direction 56, by the index or middle finger of his left hand resting on the front face of the button 51, without him needing to change the position of his left hand on the steering wheel 3. Here again, the exterior surface of the button 50 may have reliefs to limit the slipping of the fingers.

The buttons 52 and 53 have kinetics similar to those of the button 51 except that the button 52 has just one active operating position achieved by rocking forward. The buttons 52 and 53 respectively operate the cruise control and, in particular, the adjustment of a reference speed.

The buttons 54, 56 to 58 have kinetics similar to those of the button 51 with two unstable and active operating positions. The button 55 has kinetics similar to those of the button 52 with just one unstable active operating position achieved by rocking forwards. The buttons 54 to 58 respectively turn up the volume of the car radio, mute the car radio, turn down the volume of the car radio, repeat the last acoustic message given by the on-board computer and adjust the volume at which messages are emitted by the on-board computer.

The knob 59, which can be turned about its axis by the index finger and/or the middle finger of the right hand of the driver holding the rim 5, allows selection of a preset radio station or a track on a compact disc.

It will be noted that because of the distance separating the projection 35 from the envelope of revolution E, the driver can satisfactorily manipulate the various rocking buttons 50 to 58 into all their positions and can operate the knob 59 without being hampered and without trapping his fingers between the steering wheel 3 and the central pad 4. Furthermore, as the projection 35 is set back axially by more than 2.5 cm from the radially exterior region of the gap 401, and because the axial distance separating the gap 401 from the rear face 32 of the housing 30 is greater than 90 mm, the risk of a driver placing a finger opposite this gap 401 and becoming injured as a spoke 7 travels past, is limited.

Furthermore, as the rocking operating buttons 50 to 58 lie flush in the projection 35, the risk of inadvertently catching on these buttons is reduced.

It may be seen that the arrangement of the rocking buttons 50 to 58 in the projection 35, particularly of the button 50 that operates the indicators, is particularly ergonomical and makes it possible to group together onto the central pad all the controls usually arranged on the sleeve and on the central pad only. Thus, the sleeve 22 may be equipped with paddles 25 for sequential gear-shifting, and may maintain an acceptable length.

1. Steering assembly (1) for a motor vehicle, of the type comprising:
a steering column (2) comprising a steering shaft (10) capable of turning about a longitudinal axis (A),
a steering wheel (3) comprising an outer rim (5) and at least one spoke (7) connected by a first end (8) to the rim (5) and by a second end (9) to the rear end of the steering shaft to drive it in rotation about its longitudinal axis,
a fixed central pad placed substantially at the centre of the steering wheel (3) at the rear of the second end (9) of the or of each spoke (7) and connected to the rear end of the column so as to be fixed in terms of rotation when the steering shaft (10) is turning, the pad comprising at least one button (50 to 58) for operating an item of equipment of the vehicle, the button lying flush in the central pad (4) and being moveable in rocking between a position of rest and at least one active operating position, characterized in that the button (50, 51) is moveable in rocking in a first direction (60, 65) from its position of rest towards a first active operating position and, in a second direction (61, 66) which is the opposite to the first direction, from its position of rest towards a second active operating position, and in that the pad comprises a radial projection (35) on at least one of its lateral sides, in which projection the button (50, 51) lies flush, which projection is far enough away from a geometric envelope (E) of revolution defined by the rotation of the or each spoke (7) about the longitudinal axis (A) and containing the rim (5) that it allows the button (50, 51), in any of its positions, to be pushed in the first direction (60, 65) by the thumb of one hand of a driver holding a portion of the rim and pushed in the second direction (61, 66) by the index finger and/or middle finger of the same hand holding the same portion of the rim.

2. Assembly according to claim 1, characterized in that the button (50) is moveable in rocking about an axis substantially parallel to the longitudinal axis (A).

3. Assembly according to claim 2, characterized in that the radial projection (35) has at least one an free upper end (39) and in that the button (50) is provided at this end.

4. Assembly according to claim 1, characterized in that the button (51) is moveable in rocking about an axis substantially perpendicular to the longitudinal axis (A).

5. Assembly according to claim 1, characterized in that the minimum distance separating the radial projection (35) from the said geometric envelope (E) is greater than about 2 cm.

6. Fixed central pad (4) for an assembly according to one of the preceding claims, characterized in that it comprises a radial projection (35) on at least one of its lateral sides and in which at least one button (50 to 58) for operating an item of equipment of the vehicle lies flush, which button is moveable in rocking in a first direction (60, 65) from a position of rest towards a first active operating position and, in a second direction (61, 66) which is the opposite to the first direction, from its position of rest towards a second active operating position.

7. Pad according to claim 6, characterized in that the button (50) is moveable in rocking about an axis intended to be substantially parallel to the longitudinal axis (A) of the steering shaft.

8. Pad according to claim 7, characterized in that the radial projection (35) has a free end (39) intended to point upwards and in that the button (50) is provided at this end.

9. Pad according to claim 6, characterized in that the button (51) is moveable in rocking about an axis intended to be substantially perpendicular to the longitudinal axis (A) of the steering shaft.

10. Motor vehicle, characterized in that it comprises a steering assembly according to any one of claims 1 to 5.
